(19) United States
(12) Patent Application Publication
(10) Pub. No.: US 2015/0253896 A1
(43) Pub. Date: Sep. 10, 2015

(54) TOUCHSCREEN APPARATUS AND METHOD OF SENSING TOUCH

(71) Applicant: SAMSUNG ELECTRO-MECHANICS CO., LTD., Suwon (KR)

(72) Inventors: Su Jong KIM, Suwon (KR); Ji Hoon KIM, Suwon (KR); Yoon Seok OH, Suwon (KR); Do Sang KWON, Suwon (KR); Hyun Suk LEE, Suwon (KR)

(73) Assignee: SAMSUNG ELECTRO-MECHANICS CO., LTD., Suwon (KR)

(21) Appl. No.: 14/295,503

(22) Filed: Jun. 4, 2014

(30) Foreign Application Priority Data
Mar. 6, 2014 (KR) 10-2014-0026534

(51) Int. Cl. G06F 3/044

(52) U.S. Cl. CPC G06F 3/044; G06F 2203/04104

(57) ABSTRACT

A touchscreen apparatus may include: a panel unit including a plurality of first electrodes and a plurality of second electrodes intersecting with the plurality of first electrodes, and a calculating unit obtaining a plurality of pieces of digital data generated from capacitance of node capacitors formed in intersections between the plurality of first electrodes and the plurality of second electrodes. The calculating unit calculates a noise reference level of a current frame using a plurality of pieces of digital data of the current frame and a plurality of pieces of digital data of a previous frame.

### CROSS-REFERENCE TO RELATED APPLICATION

This application claims the benefit of Korean Patent Application No. 10-2014-0026534 filed on Mar. 6, 2014, with the Korean Intellectual Property Office, the disclosure of which is incorporated herein by reference.

### BACKGROUND

The present disclosure relates to a touchscreen apparatus and a method of sensing a touch.

A touchscreen apparatus such as a touchscreen, a touch pad, or the like, an input apparatus attached to a display apparatus to provide an intuitive user interface, has recently been widely used in various electronic devices such as cellular phones, personal digital assistants (PDAs), navigation devices, and the like. Particularly, as a demand for smartphones has recently increased, the use of touchscreens as touch apparatuses allowing for the providing of various touch interactions in a limited form factor has increasingly increased.

A touchscreen used in a portable device may be mainly divided into a resistive type touchscreen and a capacitive type touchscreen according to a method of sensing touch interactions. Here, the capacitive type touchscreen has advantages in that it has a relatively long lifespan and may easily implement various input methods and gestures, such that the use thereof has increased. Particularly, the capacitive type touchscreen may more easily allow for a multi-touch interface as compared with the resistive type touchscreen, such that, the capacitive type touchscreen is widely used in devices such as smartphones, and the like.

The capacitive type touchscreen includes a plurality of electrodes having a predetermined pattern and defining a plurality of nodes in which changes in capacitance occur by touch interactions. In the plurality of nodes distributed on a two-dimensional plane, changes in self-capacitance or mutual-capacitance are generated by touch interactions. Coordinates of touch interactions may be calculated by applying a weighted average method, or the like, to changes in capacitance generated at the plurality of nodes.

The touchscreen apparatus determines data having a level equal to or lower than a noise reference level as data having been generated by noise and determines data having a level equal to or higher than a touch reference level as data having been generated by an effective touch input. However, since noise components introduced into the touchscreen apparatus have magnitudes which are not constantly maintained and continuously or instantaneously varied, the noise reference level and the touch reference level need to be changed according to the introduced noise.

### RELATED ART DOCUMENT

Korean Patent Laid-Open Publication No. KR 2012-0002891

### SUMMARY

Some embodiments of the present disclosure may provide a touchscreen apparatus and a method of sensing a touch capable of calculating a noise reference level and a touch reference level of a current frame using digital data of a previous frame and the current frame.

According to some embodiments of the present disclosure, a touchscreen apparatus may include: a panel unit including a plurality of first electrodes and a plurality of second electrodes intersecting with the plurality of first electrodes; and a calculating unit obtaining a plurality of pieces of digital data generated from capacitance of node capacitors formed in intersections between the plurality of first electrodes and the plurality of second electrodes, wherein the calculating unit calculates a noise reference level of a current frame using a plurality of pieces of digital data of the current frame and a plurality of pieces of digital data of a previous frame.

The calculating unit may calculate a standard deviation value of digital data having a predetermined first threshold or above, to lower than a predetermined second threshold, among the plurality of pieces of digital data.

The first threshold may be lower than the second threshold.

The first threshold and the second threshold may have the same absolute value and opposite signs.

The calculating unit may calculate the noise reference level of the current frame by summing the standard deviation value of the current frame and the standard deviation value of the previous frame.

The calculating unit may apply different weights to the standard deviation value of the current frame and the standard deviation value of the previous frame.

The standard deviation value of the current frame and the standard deviation value of the previous frame may have a relationship expressed by the following Equation.

α+β=1 [Equation]

where α is a standard deviation value of a current frame and β is a standard deviation value of a previous frame.

The calculating unit may calculate a touch reference level from the noise reference level.

The calculating unit may calculate the touch reference level by multiplying the noise reference level by a predetermined scale coefficient.

The calculating unit may calculate the touch reference level by adding a predetermined reference level to the noise reference level.

The touchscreen apparatus may further include a driving circuit unit applying predetermined driving signals to the plurality of first electrodes.

The touchscreen apparatus may further include a sensing circuit unit detecting the capacitance from the plurality of second electrodes.

The touchscreen apparatus may further include a signal converting unit performing an analog-to-digital conversion of the capacitance to generate the plurality of pieces of digital data.

According to some embodiments of the present disclosure, a method of sensing a touch may include: obtaining a plurality of pieces of digital data; calculating a standard deviation value for digital data having a first threshold or above, to lower than a second threshold among the plurality of pieces of digital data; and calculating a noise reference level of a current frame using the standard deviation value of the current frame and the standard deviation value of a previous frame.

The first threshold may be lower than the second threshold.

The first threshold and the second threshold may have the same absolute value and opposite signs.

In the calculating of the noise reference level, the noise reference level of the current frame may be calculated by summing the standard deviation value of the current frame and the standard deviation value of the previous frame.

In the calculating of the noise reference level, different weights may be applied to the standard deviation value of the current frame and the standard deviation value of the previous frame.

In the calculating of the noise reference level, the standard deviation value of the current frame and the standard deviation value of the previous frame may have a relationship expressed by the following Equation.

α+β=1 [Equation]

where α is a standard deviation value of a current frame and β is a standard deviation value of a previous frame.

The method may further include calculating a touch reference level from the noise reference level.

In the calculating of the touch reference level, the touch reference level may be calculated by multiplying the noise reference level by a predetermined scale coefficient.

In the calculating of the touch reference level, the touch reference level may be calculated by adding a predetermined reference level to the noise reference level.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view illustrating an appearance of an electronic device including a touchscreen apparatus according to an exemplary embodiment of the present disclosure;

FIG. 2 is a diagram illustrating a panel unit that may be included in the touchscreen apparatus according to an exemplary embodiment of the present disclosure;

FIG. 3 is a diagram illustrating a cross-section of the panel unit that may be included in the touchscreen apparatus according to an exemplary embodiment of the present disclosure;

FIG. 4 is a diagram illustrating a touchscreen apparatus according to an exemplary embodiment of the present disclosure;

FIG. 5 is a flow chart illustrating a method of sensing a touch according to an exemplary embodiment of the present disclosure; and

FIG. 6 illustrates simulation data according to an exemplary embodiment of the present disclosure.

### DETAILED DESCRIPTION

Exemplary embodiments of the present disclosure will now be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

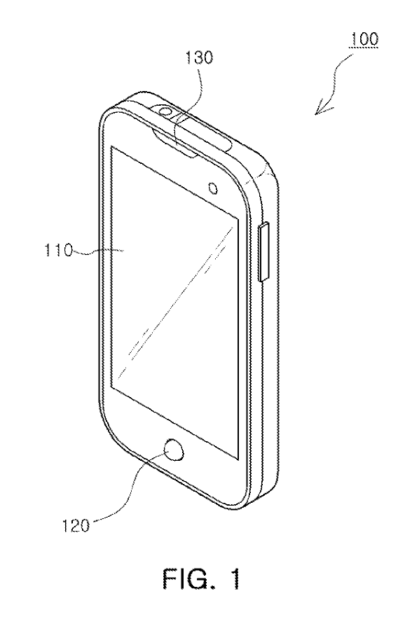

FIG. 1 is a perspective view illustrating an appearance of an electronic device including a touchscreen apparatus according to an exemplary embodiment of the present disclosure.

Referring to FIG. 1, an electronic device 100 according to the present exemplary embodiment may include a display apparatus 110 for outputting an image, an input unit 120, an audio unit 130 for outputting audio, and a touch sensing apparatus integrated with the display apparatus 110.

As shown in FIG. 1, in the case of a mobile device, the touch sensing apparatus is generally provided in a state in which it is integrated with the display apparatus, and needs to have a degree of light transmissivity high enough to transmit an image displayed by the display apparatus therethrough. Therefore, the touch sensing apparatus may be implemented by forming an electrode using a transparent and electrically conductive material such as indium tin oxide (ITO), indium zinc oxide (IZO), zinc oxide (ZnO), carbon nano tube (CNT), or graphene on a base substrate formed using a transparent film material such as polyethylene terephtalate (PET), polycarbonate (PC), polyethersulfone (PES), polyimide (PI), a polymethyl methacrylate (PMMA), or the like. In addition, the electrode may be configured of conductor fine lines formed using any one of Ag, Al, Cr, Ni, Mo, and Cu, or an alloy thereof.

The display apparatus may include a wiring pattern disposed at a bezel region thereof, and the wiring pattern is connected to the electrode. Since the wiring pattern is visually shielded by the bezel region, it may also be formed using a metal material such as silver (Ag), copper (Cu), or the like.

Since it is assumed that the touchscreen apparatus according to an exemplary embodiment of the present disclosure is operated in a capacitive type, the touchscreen apparatus may include a plurality of electrodes having a predetermined pattern. In addition, the touchscreen apparatus according to an exemplary embodiment of the present disclosure may include a capacitance sensing circuit detecting capacitance changes generated in the plurality of electrodes, an analog-to-digital converting circuit converting an output signal of the capacitance sensing circuit into a digital value, a calculating circuit determining touch interactions using data converted into the digital value, and the like.

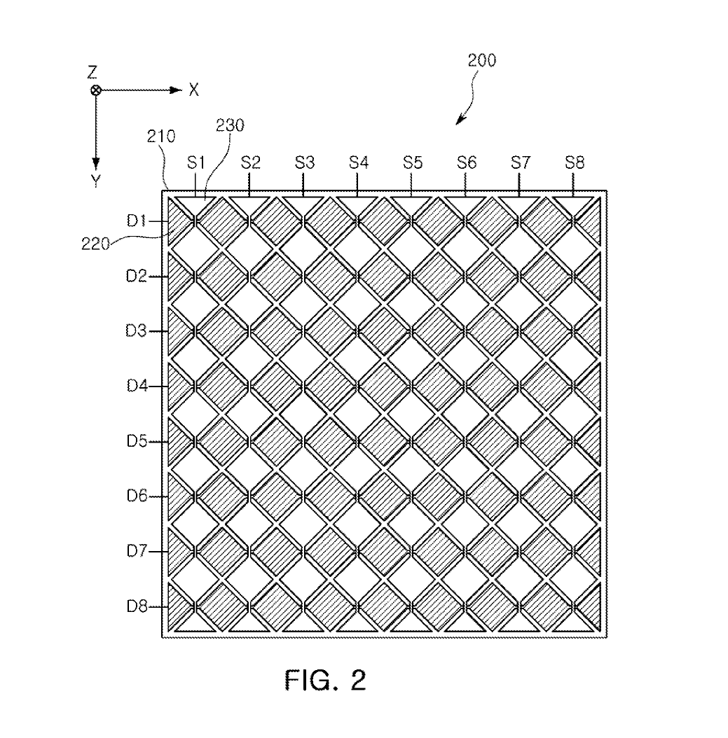

FIG. 2 is a diagram illustrating a panel unit that may be included in the touchscreen apparatus according to an exemplary embodiment of the present disclosure.

Referring to FIG. 2, the panel unit 200 according to the present exemplary embodiment may include a substrate 210 and a plurality of electrodes 220 and 230 provided on the substrate 210. Although not shown in FIG. 2, the plurality of respective electrodes 220 and 230 may be electrically connected to a wiring pattern of a circuit board, attached to one end of the substrate 210 through wirings and bonding pads. The circuit board may be provided with a controller integrated circuit (a controlling unit) mounted thereon to detect sensing signals generated in the plurality of electrodes 220 and 230 and may determine touch interactions from the sensing signals.

The plurality of electrodes 220 and 230 may be provided on one or both surfaces of the substrate 210. Although the plurality of electrodes 220 and 230 are shown as having rhomboid or diamond-shaped patterns in FIG. 2, they may also have various polygonal patterns such as rectangular patterns, triangular patterns, or the like.

The plurality of electrodes 220 and 230 may include first electrodes 220 extended in an X axis direction and second electrodes 230 extended in a Y axis direction. The first electrodes 220 and the second electrodes 230 are provided on both surfaces of the substrate 210, or are provided on different substrates 210 such that they may intersect with each other. In the case in which both of the first electrodes 220 and the second electrodes 230 are provided on one surface of the substrate 210, a predetermined insulating layer may be partially formed at intersection points between the first electrodes 220 and the second electrodes 230.

Further, in addition to a region in which the plurality of electrodes 220 and 230 are formed, with respect to a region in which wirings connected to the plurality of electrodes 220 and 230 are provided, a predetermined printed region for visually shielding the wiring generally formed of an opaque metal material may be formed on the substrate 210.

An apparatus electrically connected to the plurality of electrodes 220 and 230 to sense touch interactions may detect changes in levels of capacitance generated in the plurality of electrodes 220 and 230 by touch interactions and sense touch interactions from the detected capacitance changes. The first electrodes 220 may be connected to channels defined as D1 to D8 in the controller integrated circuit to thereby receive predetermined driving signals applied thereto, and the second electrodes 230 may be connected to channels defined as S1 to S8 to thereby be used for the touch sensing apparatus to detect a sensing signal. In this case, the controller integrated circuit may detect a change in mutual-capacitance generated between the first electrode 220 and the second electrode 230 as the sensing signal.

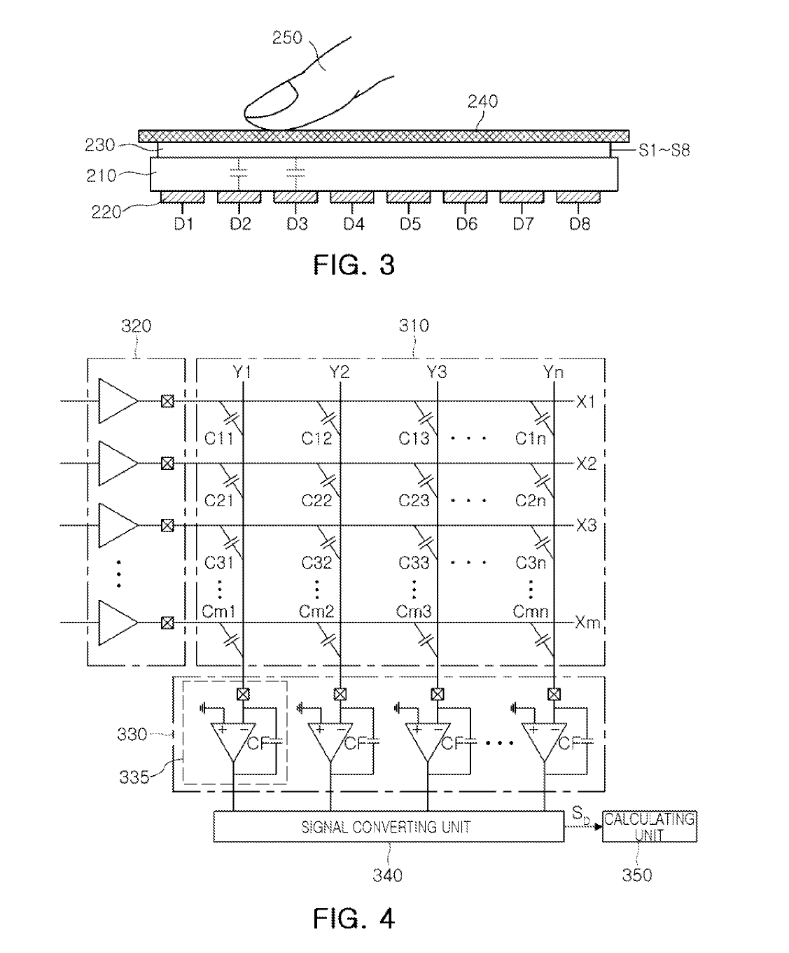

FIG. 3 is a diagram illustrating a cross-section of the panel unit that may be included in the touchscreen apparatus according to an exemplary embodiment of the present disclosure. FIG. 3 is a cross-sectional view of the panel unit 200 of FIG. 2 taken along a Y-Z plane. The panel unit 200 may further include a cover lens 240 to which a touch is applied, in addition to the substrate 210 and the plurality of sensing electrodes 220 and 230 described with reference to FIG. 2. The cover lens 240 may be provided on the second electrode 230 used to detect the sensing signal and receive touch interactions applied from a touch object 250 such as a finger, or the like.

When the driving signals are applied to the first electrodes 220 through the channels D1 to D8, mutual capacitance may be generated between the first electrodes 220 to which the driving signals are applied and the second electrodes 230. When the touch object 250 touches the cover lens 240, a capacitance change may be generated in the mutual capacitance generated between the first and second electrodes 220 and 230 that are adjacent to a region touched by the touch object 250. Changes in capacitance may be in proportion to an area of an overlapping region between the touch object 250, and the first electrodes 220 to which the driving signals are applied and the second electrode 230. In FIG. 3, the mutual capacitance generated between the first and second electrodes 220 and 230 connected to the channels D2 and D3, respectively, may be affected by the touch object 250.

FIG. 4 is a diagram illustrating a touchscreen apparatus according to an exemplary embodiment of the present disclosure.

Referring to FIG. 4, the touchscreen apparatus according to the present exemplary embodiment may include a panel unit 310, a driving circuit unit 320, a sensing circuit unit 330, a signal converting unit 340, and a calculating unit 350. In this case, the driving circuit unit 320, the sensing circuit unit 330, the signal converting unit 340, and the calculating unit 350 may be implemented in a single integrated circuit (IC).

The panel unit 310 may include a plurality of rows of first electrodes X1 to Xm (driving electrodes) extended in a first axis direction (for example, a horizontal direction of FIG. 4) and a plurality of columns of second electrodes Y1 to Yn (sensing electrodes) extended in a second axis direction (for example, a vertical direction of FIG. 4) intersecting with the first axis. The capacitance may be formed at the intersection of the plurality of first electrodes X1 to Xm and the plurality of second electrodes Y1 to Yn. Node capacitors C11 to Cmn shown in FIG. 4 show the capacitance generated at the intersection of the plurality of first electrodes X1 to Xm and the plurality of second electrodes Y1 to Yn as capacitor components.

The driving circuit unit 320 may apply predetermined driving signals to the plurality of first electrodes X1 to Xm of the panel unit 310. The driving signals may be square wave signals, sine wave signals, triangle wave signals, or the like, having a predetermined period and amplitude and be sequentially applied to the plurality of respective first electrodes X1 to Xm. Although FIG. 4 illustrates a case in which circuits for generating and applying the driving signals are individually connected to the plurality of respective first electrodes X1 to Xm, a configuration in which the driving signal is applied to the plurality of respective first electrodes X1 to Xm by including a single driving signal generating circuit and using a switching circuit may also be used. In addition, the touchscreen apparatus may be operated in a scheme in which the driving circuit unit 320 concurrently applies the driving signals to all of the first electrodes or selectively applies the driving signals to only a portion of the first electrodes to simply sense whether touch interactions are present or not.

The sensing circuit unit 330 may detect capacitance of the node capacitors C11 to Cmn from the plurality of second electrodes Y1 to Yn. The sensing circuit unit 330 may include a plurality of C-V converters 335 each including at least one operational amplifier and at least one capacitor, and each of the plurality of C-V converters 335 may be connected to the plurality of second electrodes Y1 to Yn.

The plurality of C-V converters 335 may convert the capacitance of the node capacitors C11 to Cmn to voltage signals to output analog signals. As an example, each of the plurality of C-V converters 335 may include an integrating circuit integrating the capacitance. The integrating circuit may integrate the capacitance and convert it to a predetermined voltage to output the predetermined voltage.

Although FIG. 4 illustrates a configuration of the C-V converter 335 in which a capacitor CF is disposed between an inverse terminal and an output terminal of the operational amplifier, an arrangement of the circuit configuration may also be changed. Further, although FIG. 4 illustrates a case in which the C-V converter 335 includes one operational amplifier and one capacitor, the C-V converter 335 may include a plurality of operational amplifiers and a plurality of capacitors.

In the case in which the driving signals are sequentially applied to the plurality of first electrodes X1 to Xm, since the levels of capacitance may be concurrently detected from the plurality of second electrodes, the number of C-V converters 335 may correspond to the number n of the plurality of second electrodes Y1 to Yn.

The signal converting unit 340 may generate digital signals S_{D} from the analog signals output from the sensing circuit unit 330. For example, the signal converting unit 340 may include a time-to-digital converter (TDC) circuit measuring a time in which the analog signal output in a voltage form by the sensing circuit unit 330 reaches a predetermined reference voltage level and converting the measured time into the digital signal S_{D} or an analog-to-digital converter (ADC) circuit measuring an amount by which a level of the analog signal output from the sensing circuit unit 330 is changed for a predetermined time and converting the changed amount into the digital signal S_{D}.

The calculating unit 350 may determine touch interactions applied to the panel unit 310 using the digital signals S_{D}. The calculating unit 350 may determine the number, coordinates, gesture operations, or the like, of touch interactions applied to the panel unit 310 using the digital signals S_{D}.

The digital signal S_{D}, the basis for determining touch interactions by the calculating unit 350, may be data obtained by digitalizing changes in levels of capacitance of the node capacitors C11 to Cmn, and in detail, may be data indicating a capacitance difference between a case in which touch interactions are not generated and a case in which touch interactions are generated. Typically, in the capacitive type touchscreen apparatus, a region in which the conductive object touches has reduced capacitance as compared with a region in which the touch is not generated. Therefore, the region in which the conductive object touches may indicate changes in capacitance larger than the region in which the touch is not generated.

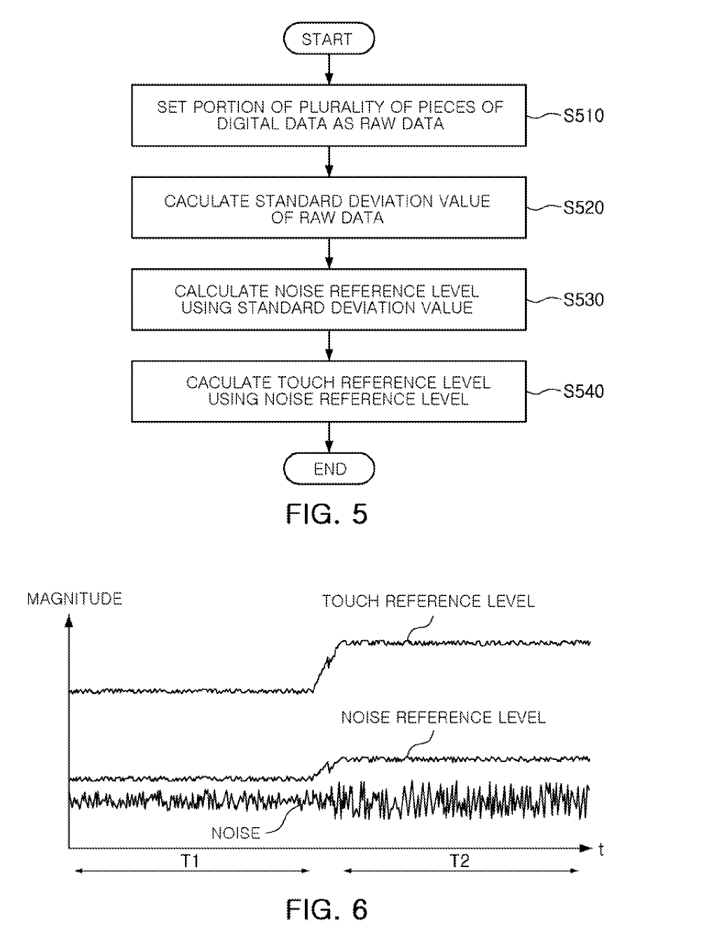

FIG. 5 is a flow chart illustrating a method of sensing a touch according to an exemplary embodiment of the present disclosure. FIG. 5 illustrates a method of calculating a noise reference level and a touch reference level. Hereinafter, the method of calculating the noise reference level and the touch reference level according to the present exemplary embodiment will be described with reference to FIGS. 4 and 5.

Digital signal S_{D} may include a plurality of pieces of digital data corresponding to the levels of capacitance of the plurality of node capacitors C11 to Cmn and the calculating unit 350 may set a portion of the plurality of pieces of digital data as raw data (S510). In detail, the calculating unit 350 may set the digital data having a first threshold or above, to lower than a second threshold, as the raw data.

The calculating unit 350 may determine the digital data having a level lower than a noise reference level as data having been generated by noise introduced through the panel or noise caused by an influence of the display apparatus, and may set the digital data having the first threshold or above, to lower than the second threshold as the raw data in order to prevent digital data generated by an effective touch from being included in the raw data for calculating the noise reference level. In this case, the second threshold may be higher than the first threshold. As an example, the first threshold and the second threshold may have the same absolute value and opposite signs.

The calculating unit 350 may calculate a standard deviation value for the raw data according to the following Equation 1 (S520). The number of raw data may be L and the calculating unit 350 may calculate the standard deviation value using the raw data of L.

$$δ = \sqrt{\frac{{\sum }_{n = 1}^{n = L} {( Raw Data ( n ) - AVG of Raw Data )}^{2}}{L}} \qquad Equation 1$$

where δ is a standard deviation value and AVG of Raw Data is the number of raw data.

The calculating unit 350 may calculate the noise reference level using the standard deviation value (S530). The calculating unit 350 may obtain a plurality of pieces of digital data corresponding to changes in levels of capacitance of a plurality of node capacitors C11 to Cmn in one frame once and may calculate the noise reference level of a current frame using a standard deviation value of the current frame and a standard deviation value of a previous frame. According to an exemplary embodiment of the present disclosure, the calculating unit 350 may calculate the noise reference level of the current frame by summing the standard deviation value of the current frame and the standard deviation value of the previous frame. In this case, the calculating unit 350 may calculate the noise reference level of the current frame by applying different weighted indices to the standard deviation value of the current frame and the standard deviation value of the previous frame. As an example, a weighted index α of the previous frame and a weighted index β of the current frame may have a relationship as in the following Equation 2. When a weight applied to the weighted index of the current frame is higher than that applied to the weighted index of the previous frame, an influence caused by peak noise may be significantly reduced. According to an example, the weighted index α of the previous frame and the weighted index β of the current frame may be larger than 0.

α+β=1 Equation 2

The noise reference level may have an upper limit value and a lower limit value which are preset. In a case in which the noise reference level is calculated by summing the standard deviation values of the current frame and the previous frame, the noise reference level is calculated to be too high or low, such that a problem may be occurred that the effective touch interaction is determined as the noise or the noise is determined as the effective touch interaction. However, this problem may be prevented by presetting the upper limit value and the lower limit value of the noise reference level.

In the case in which the noise reference level is calculated, the calculating unit 350 may calculate a touch reference level using the noise reference level (S540). The touch reference level refers to a threshold for determining the effective touch interaction. The calculating unit 350 may calculate the touch reference level by multiplying the noise reference level by a predetermined scale coefficient or adding a predetermined reference level to the noise reference level and may determine the digital data having the calculated touch reference level or above as those generated by the effective touch interaction.

FIG. 6 illustrates simulation data according to an exemplary embodiment of the present disclosure. Referring to FIG. 6, it may be appreciated that a noise level is further increased in a period T2 than in a period T1. In this case, the noise reference level and the touch reference level are increased according to the increased noise level, such that they are actively changed according to the noise.

According to exemplary embodiments of the present disclosure, since the noise reference level and the touch reference level are set according to the standard deviation of the introduced noise, the noise, continuously or instantaneously varied may be actively treated.

While exemplary embodiments have been shown and described above, it will be apparent to those skilled in the art that modifications and variations could be made without departing from the spirit and scope of the present disclosure as defined by the appended claims.

What is claimed is:

1. A touchscreen apparatus comprising:
a panel unit including a plurality of first electrodes and a plurality of second electrodes intersecting with the plurality of first electrodes; and
a calculating unit obtaining a plurality of pieces of digital data generated from capacitance of node capacitors formed in intersections between the plurality of first electrodes and the plurality of second electrodes,
wherein the calculating unit calculates a noise reference level of a current frame using a plurality of pieces of digital data of the current frame and a plurality of pieces of digital data of a previous frame.

2. The touchscreen apparatus of claim 1, wherein the calculating unit calculates a standard deviation value of digital data having a predetermined first threshold or above, to lower than a predetermined second threshold among the plurality of pieces of digital data.

3. The touchscreen apparatus of claim 2, wherein the first threshold is lower than the second threshold.

4. The touchscreen apparatus of claim 2, wherein the first threshold and the second threshold have the same absolute value and opposite signs.

5. The touchscreen apparatus of claim 2, wherein the calculating unit calculates the noise reference level of the current frame by summing the standard deviation value of the current frame and the standard deviation value of the previous frame.

6. The touchscreen apparatus of claim 5, wherein the calculating unit applies different weights to the standard deviation value of the current frame and the standard deviation value of the previous frame.

7. The touchscreen apparatus of claim 6, wherein the standard deviation value of the current frame and the standard deviation value of the previous frame have a relationship expressed by the following Equation.
α+β=1 [Equation]
where α is a standard deviation value of a current frame and β is a standard deviation value of a previous frame.

8. The touchscreen apparatus of claim 1, wherein the calculating unit calculates a touch reference level from the noise reference level.

9. The touchscreen apparatus of claim 8, wherein the calculating unit calculates the touch reference level by multiplying the noise reference level by a predetermined scale coefficient.

10. The touchscreen apparatus of claim 9, wherein the calculating unit calculates the touch reference level by adding a predetermined reference level to the noise reference level.

11. The touchscreen apparatus of claim 1, further comprising a driving circuit unit applying predetermined driving signals to the plurality of first electrodes.

12. The touchscreen apparatus of claim 1, further comprising a sensing circuit unit detecting the capacitance from the plurality of second electrodes.

13. The touchscreen apparatus of claim 1, further comprising a signal converting unit performing an analog-to-digital conversion of the capacitance to generate the plurality of pieces of digital data.

14. A method of sensing a touch, the method comprising:
obtaining a plurality of pieces of digital data;
calculating a standard deviation value for digital data having a first threshold or above, to lower than a second threshold among the plurality of pieces of digital data; and
calculating a noise reference level of a current frame using the standard deviation value of the current frame and the standard deviation value of a previous frame.

15. The method of claim 14, wherein the first threshold is lower than the second threshold.

16. The method of claim 14, wherein the first threshold and the second threshold have the same absolute value and opposite signs.

17. The method of claim 14, wherein in the calculating of the noise reference level, the noise reference level of the current frame is calculated by summing the standard deviation value of the current frame and the standard deviation value of the previous frame.

18. The method of claim 17, wherein in the calculating of the noise reference level, different weights are applied to the standard deviation value of the current frame and the standard deviation value of the previous frame.

19. The method of claim 18, wherein in the calculating of the noise reference level, the standard deviation value of the current frame and the standard deviation value of the previous frame have a relationship expressed by the following Equation.
α+β=1 [Equation]
where α is a standard deviation value of a current frame and β is a standard deviation value of a previous frame.

20. The method of claim 14, further comprising calculating a touch reference level from the noise reference level.

21. The method of claim 20, wherein in the calculating of the touch reference level, the touch reference level is calculated by multiplying the noise reference level by a predetermined scale coefficient.

22. The method of claim 20, wherein in the calculating of the touch reference level, the touch reference level is calculated by adding a predetermined reference level to the noise reference level.
